(19) United States
(12) Patent Application Publication
(10) Pub. No.: US 2005/0024552 A1
(43) Pub. Date: Feb. 3, 2005

(54) Liquid crystal display and manufacturing method thereof

(75) Inventors: Chun-Tung Tsuo, Taoyuan (TW); Shih-An Lin, Banchiau (TW); Ching-Hui Yen, Taipei (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/896,801

(22) Filed: Jul. 22, 2004

(30) Foreign Application Priority Data
Jul. 28, 2003 (TW) TW92120492

(51) Int. Cl. G02F 1/1333

(52) U.S. Cl. 349/58

(57) ABSTRACT

A liquid crystal display and a manufacturing method thereof. The liquid crystal display includes a frame, a liquid crystal display module, and an adjusting member. The liquid crystal display module is disposed within the frame. The adjusting member is disposed between the frame and the liquid crystal display module so that the liquid crystal display module can be positioned at a predetermined position within the frame. The thickness of the adjusting member is varied according to the size of the liquid crystal display module so that the liquid crystal display module is securely disposed within the frame. Furthermore, the manufacturing method includes the following steps. A frame, a liquid crystal display module, and an adjusting member are provided. Then, the adjusting member is disposed on the frame, and the liquid crystal display module is then disposed on the frame.

### BACKGROUND

The invention relates to a liquid crystal display and a manufacturing method thereof; in particular, the invention relates to a method for manufacturing a liquid crystal display that can enhance the utilization efficiency of its manufacturing mold.

Recently, liquid crystal displays have become an increasingly popular choice for use as displays of personal computers. Liquid crystal panels, however, come in several sizes and are manufactured by several companies. Thus, assembling liquid crystal panels of different sizes using a standard size frame is problematic.

The conventional solutions to the above problem are described in the following. One method is to design different molds to manufacture different sized frames for different sized liquid crystal panels. The disadvantage of such a method, however, is increased cost due to the increased number of molds.

Another method provides several change cores of different sizes for one mold. To assemble a specific panel in the liquid crystal display, the change core is selected and assembled in the mold to manufacture the specified frame for such panel. That is, when one specific frame is manufactured, one specific change core is assembled in the mold for manufacturing the frame. The disadvantage of this method, however, is that the mold is easily damaged as the change core is frequently changed, requiring repeated assembly and disassembly in the mold. Furthermore, changing cores in the mold can only be performed at the point of manufacture. As a result, the utilization efficiency of the mold decreases.

### SUMMARY

In view of this, the invention provides a liquid crystal display that can be easily assembled with various liquid crystal display modules therein.

Another purpose of the invention is to provide a method for manufacturing a liquid crystal display that can enhance the utilization efficiency of its manufacturing mold and decrease the cost thereof.

Accordingly, the invention provides a liquid crystal display including a frame, a liquid crystal display module, and an adjusting member. The liquid crystal display module is disposed within the frame. The adjusting member is disposed between the frame and the liquid crystal display module so that the liquid crystal display module can be positioned at a predetermined position within the frame.

In a preferred embodiment, the frame includes a support with a through hole and a slot connected to the through hole. The adjusting member includes an engaging portion abutted by the support, and a positioning portion is integrally formed with the engaging portion. The engaging portion includes a hook and a guiding block. The adjusting member is fixed on the support while the hook passes through the through hole and then is secured to the support. The positioning portion is abutted by the support and the liquid crystal display module respectively. The guiding block is moved along the slot so as to position the adjusting member is positioned on the support.

In another preferred embodiment, the thickness of the adjusting member is varied according to the size of the liquid crystal display module so that the liquid crystal display module is securely disposed within the frame.

In the invention, a method for manufacturing a liquid crystal display is provided. The method includes the following steps. A frame, a liquid crystal display module, and an adjusting member are provided. Then, the adjusting member is disposed on the frame, and the liquid crystal display module is disposed on the frame. The liquid crystal display module is positioned at a predetermined position within the frame such that the liquid crystal display module is abutted by the adjusting member.

In another preferred embodiment, the frame includes a first side, a second side opposing the first side, a third side connected to the first side, and a fourth side opposing the third side. The frame is provided with a plurality of supports at the first side, the second side, the third side, and the fourth side respectively. The method further includes the following steps. The size of the liquid crystal display module is measured, and the adjusting member is selected based on the size of the liquid crystal display module. The adjusting member is assembled on the support at the first side, the second side, the third side, or the fourth side based on the size of the liquid crystal display module.

### BRIEF DESCRIPTION OF THE DRAWINGS

The present invention can be more fully understood by reading the subsequent detailed description and examples with references made to the accompanying drawings, wherein:

FIG. 1 is a schematic view of a liquid crystal display as disclosed in the invention;

FIG. 2a is a perspective view of an adjusting member in FIG. 1;

FIG. 2b is a front view of the adjusting member;

FIG. 2c is a side view of the adjusting member;

FIG. 2d is a bottom view of the adjusting member;

FIG. 3a is a partially enlarged view of a frame in FIG. 1;

FIG. 3b is a schematic view of the adjusting member assembled on a support of the frame;

FIG. 3c is a partially enlarged view of FIG. 3b; and

FIG. 4 is a flow chart of a method for manufacturing a liquid crystal display, as disclosed in the invention.

### DETAILED DESCRIPTION

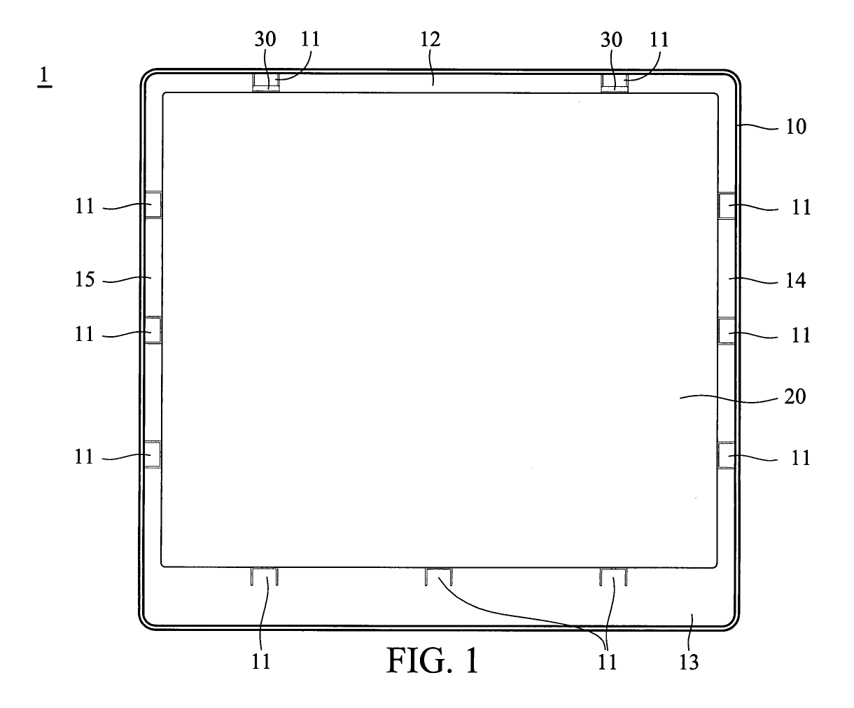

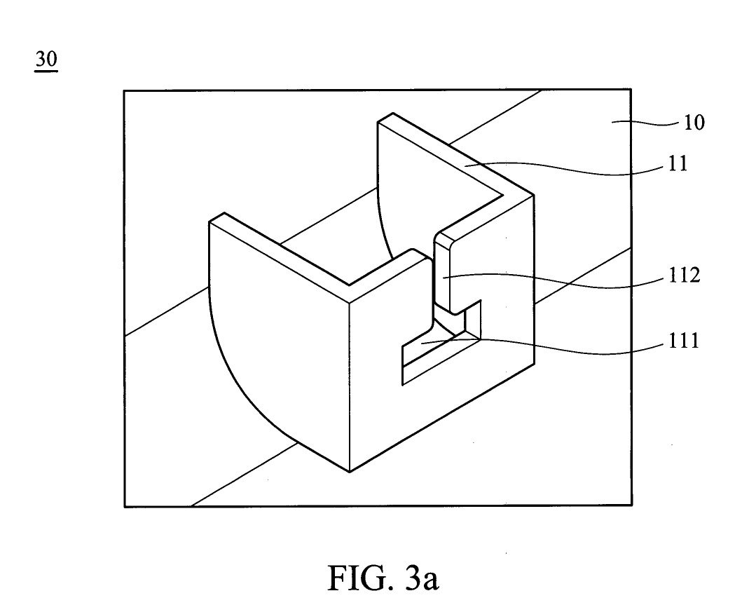

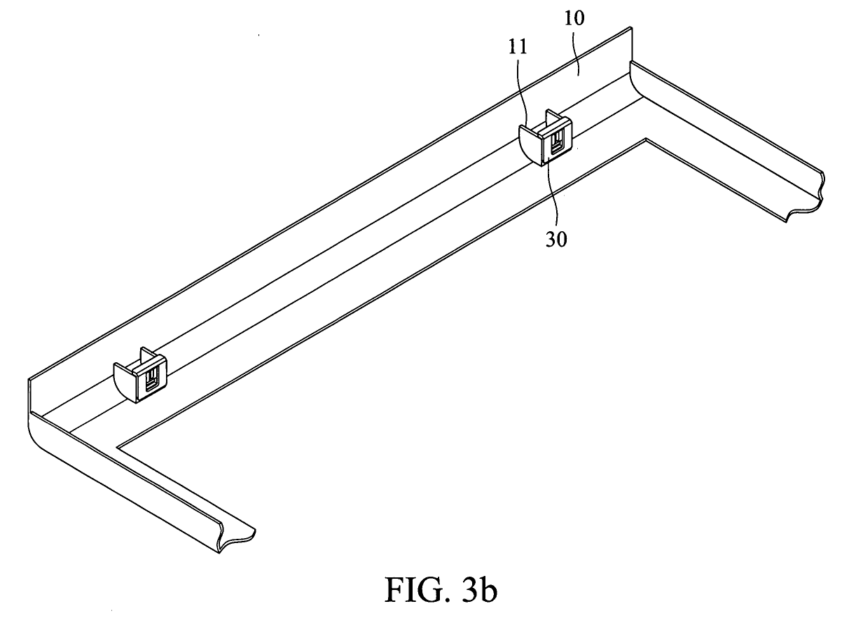

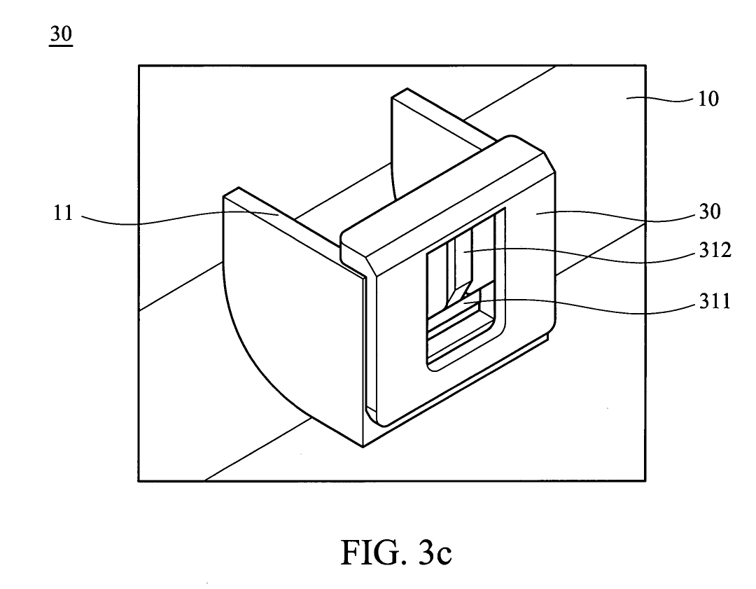

Referring to FIG. 1, a liquid crystal display 1 as disclosed in the invention, includes a frame 10, a liquid crystal display module 20, and a plurality of adjusting members 30. The frame 10 is part of the entire housing of the liquid crystal display 1, and holds the liquid crystal display module 20 therein. The frame 10 includes a first side 12, a second side 13 opposing the first side 12, a third side 14 connected to the first side 12, and a fourth side 15 opposing the third side 14. Also, the frame 10 is provided with a plurality of supports 1,1 at the first side 12, the second side 13, the third side 14, and the fourth side 15 respectively. Each adjusting member 30 is disposed in the support 11 respectively. Referring to FIG. 3a, each of the supports 11 includes a through hole 111 and a slot 112 connected to the through hole 111 respectively. In addition, it is understood that the amount of the supports is not limited to that as shown in FIG. 1.

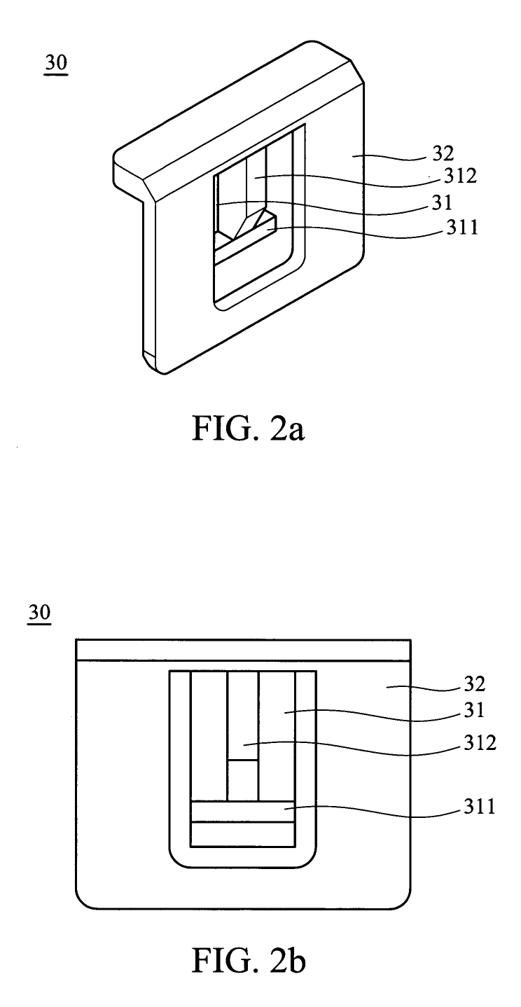

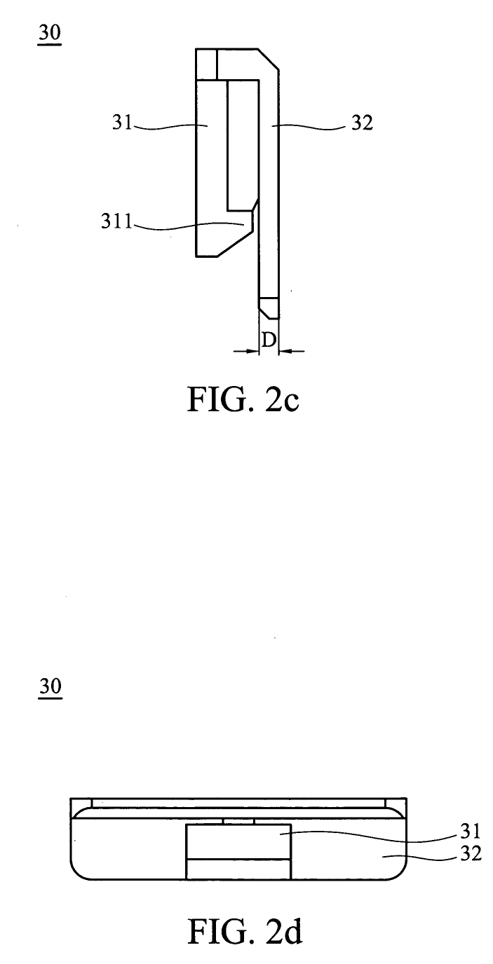

The liquid crystal display module 20 is used as a display unit of the liquid crystal display 1, and is disposed within the frame 10. Each adjusting member 30 is disposed on the support 11 of the frame 10 respectively, and is located between the frame 10 and the liquid crystal display module 20 so that the liquid crystal display module 20 can be positioned at a predetermined position within the frame 10. Specifically, as shown in FIGS. 2a-2d, Each adjusting member 30 includes an engaging portion 31 and a positioning portion 32 integrally formed with the engaging portion 31 respectively. The engaging portion 31 includes a hook 311 and a guiding block 312. As shown in FIG. 3b and FIG. 3c, the adjusting member 30 is fixed on the support 11 by the hook 311 engaging the through hole 111 of the support 11. In addition, the slot 112 of the support 110 serves to guide the guiding block 312 of the engaging portion 31 of the adjusting member 30. Since the guiding block 312 can move along the slot 112, the engaging portion 31 can be precisely abutted by the support 11 before the adjusting member 30 is fixed on the support 11. Then, the adjusting member 30 can be accurately positioned on the support 11.

Each adjusting member 30 is provided with a specific thickness D respectively. As shown in FIG. 2c, the specific thickness D is the thickness of the positioning portion 32. The specific thickness D is varied according to the size of the liquid crystal display module so that the liquid crystal display modules 20 with different sizes can be securely disposed in the same frame 20. In addition, in FIG. 1, the number of adjusting members 30 is two; however, it is not limited to this. The number of adjusting members 30 can be changed based on different situations, and the detailed description is described in the following.

For example, the sizes of the common-utilized liquid crystal display modules 20 are illustrated in the following table.

| | | A distance | A distance | A distance |
|---|---|---|---|---|
| | A distance | from a | from a | from a |
| | from a | center to | center to | center to |
| | center to | a bottom | a left | a right |
| | a top side | side | side | side |
| Module 1 | 148.25 mm | 148.25 mm | 179.25 mm | 179.25 mm |
| Module 2 | 148.9 mm | 147.4 mm | 179.15 mm | 179.15 mm |
| Module 3 | 149 mm | 147.5 mm | 179.25 mm | 179.25 mm |

To determine the size of the frame 10, the distance from a center of the opening of the frame 10 to the support at the first side 12 (the top side) is 149 mm, the distance from the center thereof to the support at the second side 13 (the bottom side) is 148.25 mm, the distance from the center thereof to the support at the fourth side 15 (the left side) is 179.25 mm, and the distance from the center thereof to the support at the third side 14 (the right side) is 179.25 mm. When the module 1 in the table is assembled in the frame 10, the adjusting members 30 are disposed on the supports 11 at the first side 12, and the specific thickness D of the adjusting member 30 is 0.75 mm (149-148.25). In addition, when the module 3 in the table is assembled in the frame 10, the adjusting members 30 are disposed on the supports 11 at the second side 13, and the specific thickness D of the adjusting member 30 is 0.75 mm (148.25-147.5).

The structure of the liquid crystal display of the invention is described as above, and the manufacturing method thereof is described in the following.

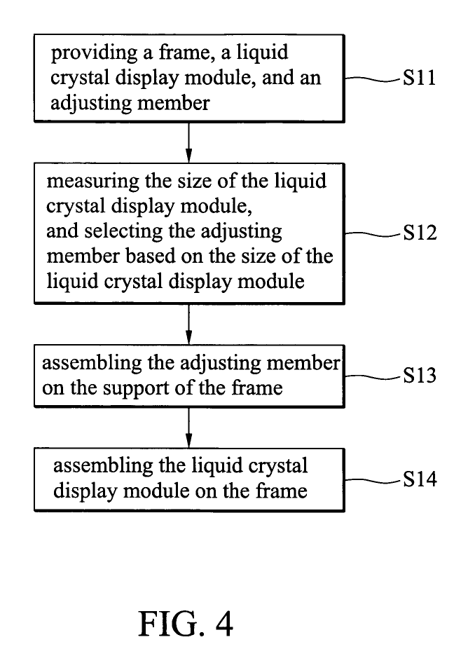

Referring to FIG. 4, in step S11, the frame 10, the liquid crystal display module 20, and the adjusting members 30 are provided. Then, in step S12, the size of the liquid crystal display module 20 is measured, and the adjusting member 30 is selected based on the size of the liquid crystal display module 20. Sequentially, in step S13, the selected adjusting member 30 is disposed on the support 11 at the first side 12, the second side 13, the third side 14, or the fourth side 15 of the frame 10. Finally, in step S14, the liquid crystal display module 20 is disposed on the frame 20. By the adjusting member 30, the liquid crystal display module 20 can be positioned at a predetermined position in the frame 10.

As stated above, by additionally assembling the adjusting member in the invention, the liquid crystal display module can be precisely positioned in the frame. Thus, unlike the conventional manufacturing method, there is no need to manufacture different molds for different liquid crystal modules, or change the change core in the mold. As a result, the utilization efficiency of the mold can be increased, and the cost of the mold can be reduced. Additionally, the entire process of the manufacturing method can be modularized.

While the invention has been described by way of example and in terms of the preferred embodiments, it is to be understood that the invention is not limited to the disclosed embodiments. To the contrary, it is intended to flipper various modifications and similar arrangements (as would be apparent to those skilled in the art). Therefore, the scope of the appended claims should be accorded the broadest interpretation so as to encompass all such modifications and similar arrangements.

1. A liquid crystal display comprising:
a frame;
a liquid crystal display module disposed in the frame; and
an adjusting member disposed between the frame and the liquid crystal display module so that the liquid crystal display module is positioned at a predetermined position within the frame.

2. The liquid crystal display as claimed in claim 1, wherein the frame includes a support, and the adjusting member includes an engaging portion abutted by the support.

3. The liquid crystal display as claimed in claim 2, wherein the engaging portion includes a hook, the support has a through hole, and the hook passes through the through hole and then is secured to the support, so that the adjusting member is fixed on the support.

4. The liquid crystal display as claimed in claim 3, wherein the adjusting member further includes a positioning portion integrally formed with the engaging portion, and the positioning portion is abutted by the support and the liquid crystal display module respectively.

5. The liquid crystal display as claimed in claim 4, wherein the engaging portion includes a guiding block, the support includes a slot connected to the through hole, the guiding block is moved along the slot so as to position the adjusting member on the predetermined position.

6. The liquid crystal display as claimed in claim 1, wherein a thickness of the adjusting member is varied according to the size of the liquid crystal display module so that the liquid crystal display module is securely disposed within the frame.

7. A method for manufacturing a liquid crystal display, comprising:
providing a frame, a liquid crystal display module, and an adjusting member;
assembling the adjusting member with the frame; and
positioning the liquid crystal display module at a predetermined position within the frame such that the liquid crystal display module is abutted by the adjusting member.

8. The method as claimed in claim 7, further comprising a step of measuring the size of the liquid crystal display module, and selecting the adjusting member based on the size of the liquid crystal display module.

9. The method as claimed in claim 7, wherein the frame includes a support, and the adjusting member is disposed on the support.

10. The method as claimed in claim 9, wherein the frame has a first side and a second side facing the first side, and a plurality of supports are provided at the first side and the second side respectively, and the method further comprises a step of:
measuring the size of the liquid crystal display module, selecting the adjusting member based on the size of the liquid crystal display module, and assembling the adjusting member with one of the supports at the first side or the second side.

11. The method as claimed in claim 10, wherein the frame has a third side connected to the first side, and a fourth side facing the third side, the frame is provided with a plurality of supports at the third side and the fourth side respectively, and the method further comprises:
assembling the adjusting member with one of the supports at the first side, the second side, the third side or the fourth side based on the size of the liquid crystal display module.
